(19) United States
(12) Patent Application Publication
(10) Pub. No.: US 2023/0086546 A1
(43) Pub. Date: Mar. 23, 2023

(54) POLYMER RETENTION SCREENING METHOD

(71) Applicant: BASF SE, Ludwigshafen am Rhein (DE)

(72) Inventors: Kristin Gabriele Mohr, Limburgerhof (DE); Lu Zhang, Tarrytown, NY (US); Leonora Ethleen Leigh, Tarrytown, NY (US); Padma P. Varanasi, Wyandotte, MI (US)

(21) Appl. No.: 17/908,273

(22) PCT Filed: Mar. 2, 2021
(86) PCT No.: PCT/US2021/020425

§ 371 Date: Aug. 31, 2022

Related U.S. Application Data
(60) Provisional application No. 62/985,461, filed on Mar. 5, 2020.

(51) Int. Cl. B01J 20/281; B01D 15/26; B01J 20/04; B01J 20/30; G01N 30/86

(52) U.S. Cl. CPC B01J 20/281; B01D 15/265; B01J 20/048; B01J 20/3071; G01N 30/8641; B01J 2220/58; G01N 2030/027

(57) ABSTRACT

The present invention discloses analytical high throughput methods for accurately, reliably, and efficiently screening and identifying polymers that are substantive to a particular material, such as hydroxyapatite. The present invention also discloses liquid chromatography columns for screening and identifying polymers that are substantive to a particular material, methods of preparing such liquid chromatography columns, and kits that may be used to screen and identify polymers that are substantive to a particular material.

### FIELD OF THE INVENTION

The present invention relates to methods for screening polymer retention on a material, such as, without limitations hydroxyapatite surface. The present invention also relates to liquid chromatography columns that may be used in the methods described herein.

### BACKGROUND OF THE INVENTION

There is a widespread market for oral care products that provide various benefits through delivery of active ingredients to the oral cavity, such as, teeth whitening and anti-plaque agents, to name a few. Delivery of an effective amount of these active ingredients to the oral cavity relies, among other factors, on the duration that an individual brushes their teeth, rinses their mouth, and so on (depending on the oral care product). For instance, individuals are encouraged to brush their teeth for at least one minute. However, most consumers brush their teeth for less than one minute. Since most consumers apply the oral care product for a shorter duration than recommended, it would be beneficial to formulate oral care products that deliver the active ingredients to the consumer’s oral cavity faster and are formulated in a manner that allows the active ingredients to retain on the target surface in the oral cavity (e.g., tooth surface) longer.

Existing methods for screening and identifying polymers that are strongly substantive to a surface material involve models that take days. For instance, screening and identifying polymers that are substantive to a hydroxyapatite (HAP) surface is currently done using a static whitening model with HAP substrate that extends over a duration of at least three days. It would be beneficial to identify a high throughput polymer screening method that enables screening a large number of polymers expediently.

### SUMMARY

It is an object of certain embodiments of the disclosure to expediently screen and identify polymers that are substantive to a material.

It is another object of certain embodiments of the disclosure to accurately and reliably identify polymers that are substantive to a material.

It is a further object of certain embodiments of the disclosure to design a high throughput method for screening and identifying polymers that are substantive to a material (e.g., a hydroxyapatite surface, or a saliva coated hydroxyapatite surface).

It is yet another object of certain embodiments of the disclosure to provide a liquid chromatography column for implementing the high throughput polymer screening methods described herein and/or to provide a method for preparing such a liquid chromatography column.

The above objects of the present invention and others may be achieved by the present invention which in certain embodiments is directed to a method for screening and identifying polymers that are substantive to a material, a method for screening and identifying polymers that are substantive to hydroxyapatite (or to saliva coated hydroxyapatite), a liquid chromatography column comprising saliva coated hydroxyapatite, a method for preparing a liquid chromatography column comprising saliva coated hydroxyapatite, a kit for screening and identifying polymers that are substantive to a material, and/or a system for screening and identifying polymers that are substantive to a material.

In certain embodiments, the method for screening and identifying polymers that are substantive to a material includes running a solution of a test polymer through a liquid chromatography (LC) column that includes the material to determine a retention time profile for the test polymer. A longer retention time profile as compared to a baseline may be indicative of the test polymer being more substantive to the material as compared to the reference polymer used to create the baseline. In certain embodiments, the method may further include pre-conditioning the LC column and/or coating the LC column with sterilized saliva or other solution (e.g., to mimic the oral cavity environment).

In certain embodiments, the method for screening and identifying polymers that are substantive to a hydroxyapatite (HAP) surface includes running a solution of a test polymer through the HAP LC column to determine a retention time profile for the test polymer. The method may optionally include coating an HAP LC column with sterilized saliva (e.g., from natural saliva or an artificial saliva substitute) prior to running the test polymer through the HAP LC column. A longer retention time profile for the test polymer as compared to a baseline may be indicative of the test polymer being more substantive to the HAP (or to sterilized saliva coated HAP) as compared to the reference polymer used to create the baseline. In certain embodiments, the method may further include pre-conditioning the LC column.

In certain embodiments, the liquid chromatography column for screening and identifying polymers that are substantive to HAP includes an HAP LC column coated with sterilized saliva.

In certain embodiments, the method for preparing a LC column for screening and identifying polymers that are substantive to HAP includes introducing about 1 mL to about 10 mL sterilized saliva directly to a HAP LC column, incubating the sterilized saliva coated HAP LC column for about 5 minutes to about 5 hours, and washing the incubated HAP LC column with running buffer to wash out any unbound sterilized saliva.

In certain embodiments, the kit for screening and identifying polymers that are substantive to a material includes a HAP LC column (bare HAP LC column or sterilized saliva coated HAP LC column), a test polymer, and one or more of: reference polymer, sterilized saliva, running buffer, low ionic strength equilibration buffer, and/or high ionic strength equilibration buffer.

In certain embodiments, the system for screening and identifying polymers that are substantive to a material includes an analytical tool (such as a high pressure liquid chromatography (HPLC) tool), a HAP LC column (bare HAP LC column or sterilized saliva coated HAP LC column), and one or more devices (such as, a computer, a processor, a display screen, and so on) operatively connected to each other.

### BRIEF DESCRIPTION OF THE DRAWINGS

The above and other features of the present disclosure, their nature, and various advantages will become more apparent upon consideration of the following detailed description, taken in conjunction with the accompanying drawings, in which:

FIG. 1 depicts an existing experimental model used for evaluating the benefits of various polymers (e.g., anti-staining or whitening benefits).

FIG. 2A depicts an illustration of a HAP LC column and an analytical method for screening and identifying polymer retention on HAP surface according to an embodiment described herein.

FIG. 2B depicts an illustration of a HAP LC column coated with sterilized saliva and an analytical method for screening and identifying polymer retention on a saliva coated HAP surface according to an embodiment described herein.

FIG. 2C depicts an exemplary chromatogram of resulting from running the analytical methods described herein for screening and identifying polymer retention on a material.

FIGS. 3A and 3B depict charts summarizing the lightness and delta E*ab, respectively, measured for HAP disks after treatment with treatment solutions.

FIGS. 4A and 4B depict charts summarizing the lightness and delta E*, respectively, measured for HAP disks after treatment with various treatment solutions.

### DETAILED DESCRIPTION

The present invention is directed to analytical methods, liquid chromatography (LC) columns, kits, and systems for accurately, reliably, and efficiently screening and identifying polymers that are substantive to a particular material, such as a bare hydroxyapatite (HAP) material or a sterilized saliva coated HAP material. The analytical methods, LC columns, kits, and systems disclosed herein may apply to a wide variety of polymers and may screen through a large number of polymers expediently.

The difference between existing methods and the inventive methods disclosed herein may be better understood in light of the below description with respect to the figures. The description of the figures should be viewed as merely exemplary and non-limiting.

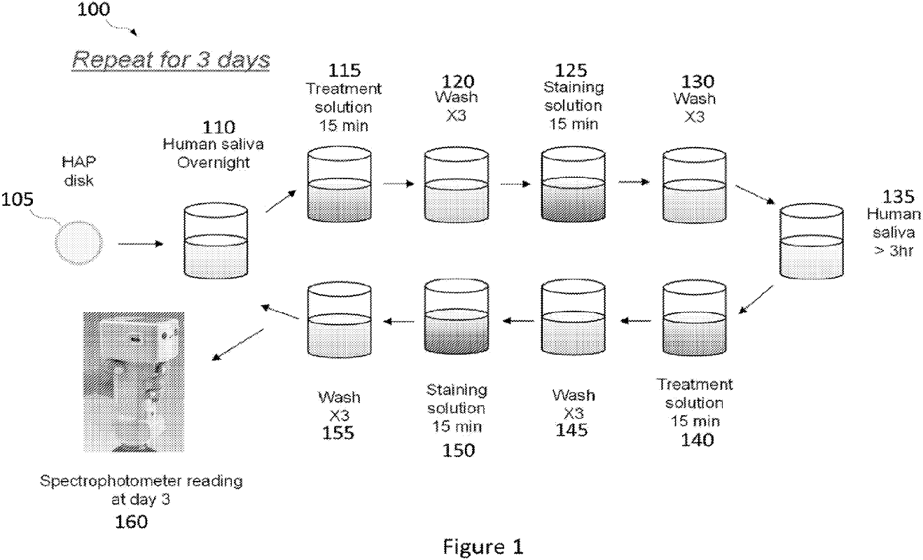

FIG. 1 depicts an existing experimental model 100 used for evaluating the benefits of various polymers. The exemplary model 100 depicted in FIG. 1 illustrates a method used for evaluating the whitening benefits of various polymers. However, certain variations of the exemplary model 100 may be used to screen various polymers for other beneficial properties, such how substantive a polymer is to a particular material.

Model 100 is an example of a method that can be currently used to screen and identify polymers that are substantive to hydroxyapatite (HAP). HAP disks 105 are utilized to mimic a tooth surface. HAP disk 105 is submerged in human saliva overnight, in accordance with step 110. Subsequently, HAP disk 105 is treated with a treatment solution for 15 minutes, in accordance with step 115. The treatment solution contains about 0.5 wt% to about 5 wt%, about 1 wt% to about 3 wt%, or about 2 wt% polymer solutions (e.g., test polymer or reference polymer) or deionized water as a control.

“Polymer solution” as used herein refers to an aqueous polymer solution with a polymer concentration of about 20 wt% to about 60 wt%, about 30 wt% to about 50 wt%, or about 35 wt% to about 45 wt%, based on total weight of the polymer solution. Thus, an exemplary treatment solution, containing about 2 wt% polymer solution that has 40 wt% polymer, would contain about 0.8 wt% polymer, based on total weight of the treatment solution.

After treatment with a polymer solution, HAP disk 105 is washed three times with deionized water, in accordance with step 120. Thereafter, washed HAP disk 105 is submerged in a staining solution for 15 minutes, in accordance with step 125. The staining solution may be prepared by steeping tea bags (e.g., 1-3 tea bags) in deionized water (e.g., about 50 ml to about 200 ml boiled deionized water). After staining, HAP disk 105 is washed three times with deionized water, in accordance with step 130.

Subsequently, washed HAP disk 105 is submerged in saliva (e.g., human saliva or a saliva substitute) for about 3 hours or more, in accordance with step 135. Afterwards, steps 115 through 130 are repeated as depicted in steps 140 through 155. Specifically, HAP disk 105 is treated for 15 minutes with a treatment solution (step 140), washed three times with deionized water (step 145), submerged in a staining solution for 15 minutes (step 150), and washed three times with deionized water (step 155).

Steps 110 through 155 are intended to mimic an individual’s daily hygienic routine of washing and/or brushing teeth twice daily. Steps 110 through 155 are repeated for three days. At the end of the third day, a spectrophotometer is utilized to assess the whitening performance of the various polymers studied, in accordance with step 160. The spectrophotometer is used to measure lightness and delta E*.

A test polymer that results in greater lightness values is indicative of a polymer that has better anti-staining/whitening properties as compared to a reference polymer and could also be indicative of that test polymer being more substantive to a HAP surface. A test polymer that results in smaller difference in lightness (e.g., lightness after three day model as compared to before exposing the HAP disk to the three day model) as compared to a reference polymer may also be indicative of that test polymer being more substantive to a HAP surface and/or have better anti-staining/whitening properties.

The above described model may be performed simultaneously for a number of test polymers. However, the model is time consuming and tedious. It would be beneficial to identify a high throughput method that would enable expedient, accurate, and reliable screening of a large number of polymers to identify lead polymer candidates that are substantive to a material of interest, such as a HAP surface. Once lead polymer candidates are identified, model 100 may be utilized to mimic an individual’s daily hygienic routine and confirm the performance of the lead polymer candidates.

In some embodiments, the instant disclosure is directed to such high throughput methods for screening a large number of polymers quickly, efficiently, and reliably to identify polymers that are substantive to a particular material. While the description herein will discuss and exemplify methods for screening and identifying polymers that are substantive to a hydroxyapatite (HAP) surfaces, the disclosure is not limited to HAP surfaces. A similar method may be utilized to screen and identify polymers that are substantive to other materials.

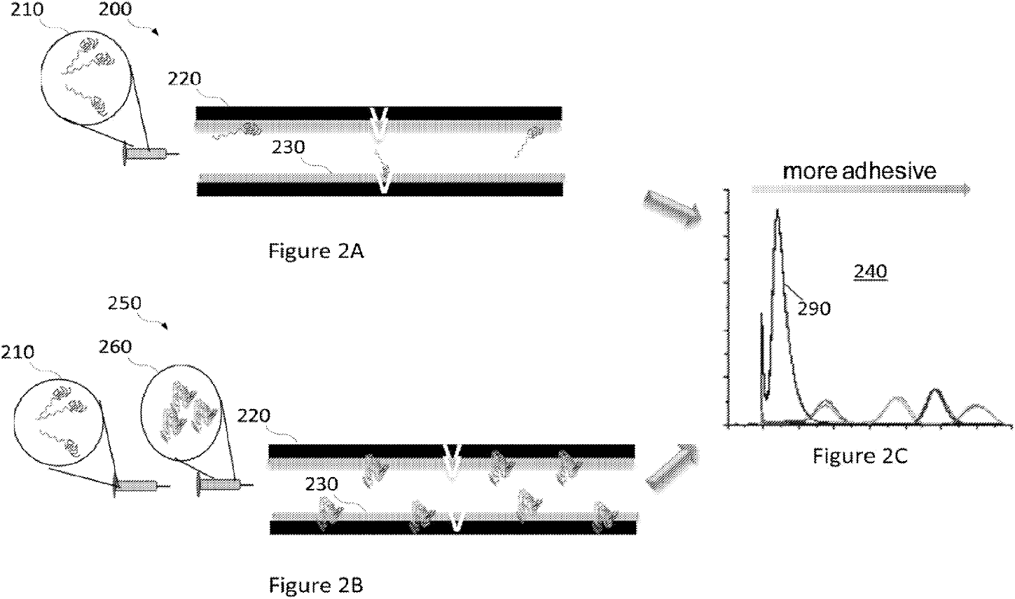

FIG. 2A depicts an illustration of analytical method 200 for screening and identifying polymer retention on HAP surface according to an embodiment described herein. The method may include running a solution of a test polymer 210 through a LC column 220 comprising a material 230 to determine a retention time profile 240 for the test polymer. The material 230 in this example is HAP. However, retention to other materials may be tested using a similar analytical method so long as a suitable LC column with the particular material of interest is utilized.

According to this method and as shown in FIG. 2C, a longer retention time profile of a test polymer as compared to a baseline may be indicative of the test polymer being more substantive to the material 230 as compared to the reference polymer used to generate the retention time profile of the baseline. A longer retention time profile for a test polymer is indicative that the test polymer retains longer on the material 230, which is indicative of the polymer sticking/adhering better to the material 230.

“Retention time profile,” as used herein refers to the time that the test polymer elutes from the LC column as evidenced by peaks in the resulting chromatogram for each test polymer. In addition to determining the time points for the peaks for each test polymer, the area percentages associated with each peak in the chromatogram may also be recorded. The retention time profile along with the associated area percentages provide information as to when the test polymer in its entirety has eluted from the LC column and how long the test polymer was retained/adhered/stuck to the LC column.

In certain embodiments, method 200 may further include running a solution of a reference polymer through the LC column 220 to determine a retention time profile forming the baseline 290 (FIG. 2C). This baseline determination step may be performed prior to running the test polymer, after running the test polymer solution, or between various test polymers solution runs.

The polymer solutions screened through LC column 220 may include the polymer (whether test polymer or reference polymer) diluted in a running buffer. The running buffer being the buffer used when flowing the polymer solution through the LC column 220. The polymer (whether test polymer or reference polymer) may be present in the polymer solution at concentration ranging from about 1 mg/mL to about 20 mg/mL, from about 3 mg/mL to about 18 mg/mL, from about 5 mg/mL to about 15 mg/mL, or from about 8 mg/mL to about 12 mg/mL. The running buffer may be a low ionic strength buffer with physiological pH. In certain embodiments, the running buffer is 10 mM sodium phosphate, 0.3 mM CaCl₂, and has a pH ranging from about 5.5 to about 7 (or from about 6.0 to about 7, or from about 6.5 to about 7).

The polymer solution may be run through LC column 220 at an isocratic flow ranging from about 0.1 ml/min to about 5 ml/min, from about 0.3 ml/min to about 3 ml/min, from about 0.5 ml/min to about 2 ml/min, or from about 0.75 ml/min to about 1.5 ml/min. The run time of the polymer solution through LC column 220 may range from about 1 minute to about 3 hours, from about 5 minutes to about 1.5 hours, from about 10 minutes to about 30 minutes, or from about 12 minutes to about 20 minutes. The flow rate and the run time may be optimized to accurately and reliably identify whether a test polymer is substantive to material 230 while being expedient enough to screen through a large number of test polymers in a relatively short period of time (as compared to the time it would take to obtain similar results using the experimental model of FIG. 1).

In certain embodiments, LC column 220 with material 230 may be pre-conditioned prior to running a polymer solution (whether a test polymer solution or a reference polymer solution) there-through. Pre-conditioning LC column 220 may include performing one or more of (a) through (d), enumerated below, one or more times:
(a) washing LC column 220 with water, and/or
(b) washing LC column 220 with a low ionic strength equilibration buffer, and/or
(c) washing LC column 220 with a high ionic strength equilibration buffer, and/or
(d) equilibrating LC column 220 with a running buffer.

An exemplary suitable low ionic strength equilibration buffer may include, without limitations, 10 mM sodium phosphate at a physiological pH ranging from about 5.5 to about 7 (or from about 6.0 to about 7, or from about 6.5 to about 7). An exemplary suitable high ionic strength equilibration buffer may include, without limitations, 500 mM sodium phosphate at a physiological pH ranging from about 5.5 to about 7 (or from about 6.0 to about 7, or from about 6.5 to about 7). An exemplary suitable running buffer may include, without limitations, 10 mM sodium phosphate, 0.3 mM CaCl₂, and has a pH ranging from about 5.5 to about 7 (or from about 6.0 to about 7, or from about 6.5 to about 7). These buffers are merely exemplary and should not be construed as limiting. Other low ionic strength and/or high ionic strength and/or running buffers may be utilized to pre-condition LC column 220.

In one embodiment, column 220 may be pre-conditioned by performing all of (a) through (d) enumerated above in the following sequence:

First, LC column 220 is washed with water, in accordance with (a) above, for five column volumes; second, LC column 220 is washed with a low ionic strength equilibration buffer, in accordance with (b) above, for five column volumes; third, LC column 220 is washed with a high ionic strength equilibration buffer, in accordance with (c) above, for five column volumes; fourth, LC column 220 is washed with a low ionic equilibration buffer, in accordance with (b) above, for five column volumes; fifth, LC column 220 is equilibrated with running buffer, in accordance with (d) above.

The order and number of column volumes used for each of steps (a) through (d) that are performed may vary and should not be construed as limited. For instance, in certain embodiments, each of steps (a) through (d) may be independently performed with a solution amount ranging from 0 column volumes to about 20 column volumes, from about 1 column volumes to about 18 column volumes, from about 2 column volumes to about 15 column volumes, from about 3 column volumes to about 10 column volumes, or from about 4 column volumes to about 6 column volumes. “Column volume” refers to an amount of a solution needed to fill the volume of one LC column, such as LC column 220.

In certain embodiments, LC column 220 including material 230 may further be coated with sterilized saliva 260, as depicted in FIG. 2B. FIG. 2B depicts an illustration of analytical method 250 for screening and identifying polymer retention on a saliva coated HAP surface according to an embodiment described herein. The method may include coating a LC column 220 comprising a material 230 (e.g., HAP) with sterilized saliva 260 prior to running the test polymer solution 210.

In certain embodiments, coating LC column 220 with sterilized saliva 260 includes introducing about 1 mL to about 10 mL, about 2 mL to about 8 mL, or about 3 mL to about 5 mL of the sterilized saliva 260 directly onto the LC column 220. Thereafter, coating LC column 220 with sterilized saliva 260 may further include capping the LC column 220 and incubating it for about 5 minutes to about 5 hours, about 10 minutes to about 3 hours, about 15 minutes to about 1 hour, or about 20 minutes to about 40 minutes. After the incubation period, LC column 220 may be re-installed into a liquid chromatography system (e.g., HPLC) and washed with running buffer to wash out unbound or loosely bound proteins from the sterilized saliva. This wash may be performed over a duration of about 1 minute to about 30 minutes, about 5 minutes to about 15 minutes, or about 8 minutes to about 12 minutes.

In certain embodiments, sterilized saliva 260 may be prepared by centrifuging saliva at about 1000 rpm to about 3000 rpm, about 1500 rpm to about 2500 rpm, or about 1900 rpm to about 2100 rpm to collect supernatant. Thereafter, the supernatant may be sterilized under ultraviolet light for about 30 minutes to about 2 hours, about 45 minutes to about 90 minutes, or about one hour to generate the sterilized saliva.

In certain embodiments, the methods described herein may further include determining the retention times and the associated area percentages of the peak related to a respective retention time. The retention times and the associated area percentages of the peak related to a respective retention time provides information as to how long a particular polymer sticks to the column. A longer retention time combined with a larger area percentage for the peaks associated with the longer retention time are indicative of a polymer that is more sticky and/or more substantive and/or adheres longer to the LC column material (e.g., HAP).

In some embodiments, the method steps disclosed herein may be performed by one person, by several individuals, or may be automated and performed on one or more analytical tools. For example, in one embodiment, preparing a sample may be performed by one or more individual(s) utilizing one or more analytical tool(s), analyzing the sample may be performed partially in one or more analytical tool(s) (e.g., HPLC machine) and partially by one or more individual(s) or by a processor configured to record and compare retention times and area percentages associated with various peaks.

The advantages of the methods disclosed herein include, but are not limited to: 1) accurate and reliable screening and identification of polymers that are substantive to a particular material; 2) quicker results that may be attained in minutes using the high throughput method described herein as compared to the experimental model currently used which could take days; and 3) ability to mimic oral conditions (e.g., by coating a HAP LC column with saliva) to characterize a polymer’s performance with or without saliva.

Certain embodiments of the instant disclosure may be directed to a liquid chromatography (LC) column for screening polymers that are substantive to HAP surface. The LC column may include a HAP LC column coated with sterilized saliva.

Certain embodiments of the instant disclosure may be directed to a method of preparing a LC column for screening polymers that are substantive to HAP surface. The method may include coating a HAP LC column with sterilized saliva as described hereinabove. The method may also include preparing sterilized saliva, prior to coating the HAP LC column with it, as described hereinabove.

Certain embodiments of the instant disclosure may be directed to a kit for screening polymers that are substantive to HAP surface. The kit may include a HAP LC column and a test polymer. In certain embodiments, the kit further includes one or more of: reference polymer, running buffer, sterilized saliva, low ionic strength equilibration buffer, high ionic strength equilibration buffer, and a mixture thereof.

In some embodiments, this disclosure may be directed to a system for screening and identifying polymers that are substantive to a particular material (e.g., hydroxyapatite). The system may comprise an LC column with the material (e.g., hydroxyapatite) and one or more analytical tools (e.g., the kind that may be used for preparing or for analyzing a polymer solution sample).

Exemplary analytical tools that may be part of the systems disclosed herein include, without limitations, an HPLC machine, an LC column, a centrifuge (e.g., for preparing sterilized saliva), a UV light (e.g., for sterilizing a saliva sample), a processor, a computer, a display, and any combination thereof. Any combination of analytical tools that may form the systems disclosed herein may be operatively connected. In certain embodiments, the one or more analytical tool(s) may be separate and an individual may manually utilize various analytical tools in the order they see fit to implement methods disclosed herein. In other embodiments, the one or more analytical tool(s) may be operatively connected such that methods for comparing the retention times and area percentages of peaks associated with certain retention times may be automated and may perform the method in response to a programmed algorithm.

Polymers that are screened and identified as lead candidates (i.e., most substantive to a particular material such as HAP), may be utilized in oral care compositions that could benefit from highly substantive polymers. For instance, oral care compositions for preventing or minimizing formation of new stains on a tooth surface may include polymers that are highly substantive to HAP and would form a barrier on a tooth surface that could protect the tooth surface from stain sources (e.g., food, caffeine, tea, etc). Similarly, oral care compositions for protecting a tooth surface from acids, minimizing gum irritation, sensitization, and sloughing of the epithelium by providing a barrier to the tooth surface, may also include polymers that are identified by the methods described herein as highly substantive to HAP. The highly substantive polymer is believed to bind and retain onto the tooth surface and act as a sealant to prevent bacterial adsorption and provide a long lasting effect on the prevention and/or reduction and/or removal of stains and bacteria accumulation on the tooth surface. The following examples illustrate one application for screening and identifying polymers that are substantive to HAP and utilizing them in an exemplary oral care composition.

### ILLUSTRATIVE EXAMPLES

### Example 1 - Screen and Identify Polymers for Whitening Benefits

In this example, the methods described herein were used to screen and identify polymers that have prolonged retention onto the tooth surface and are substantive to the tooth surface. Without being construed as limiting, it is believed that polymers that retain longer on the tooth surface form a barrier shield that reduces stain deposition on the tooth surface. The polymers identified as most substantive to the tooth surface (using the methods described herein) were evaluated to determine their efficacy in preventing stain adsorption onto HAP discs. The efficacy of the polymers in preventing stain adsorption onto HAP discs was evaluated as neat polymers as well as when the polymers were formulated in a mouthwash formulation. Table 1 depicts an exemplary implementation of a method according to embodiments disclosed herein for screening and identifying polymers that are substantive to a HAP surface.

TABLE 1

Exemplary Implementation of a Substantive Polymer Screening Method

| | |
|---|---|
| | Inventive Method |
| Instrument Type | HPLC |
| Detector | Refractive Index |
| Column(s) | Surface Material Dependent In this Example, the Bio-Scale Hydroxyapatite Type I Column (CHT2-I) from BIO RAD was used |
| Running Buffer | 10 mM sodium phosphate, 0.3 mM CaCl₂ |
| Runtime | 15 minutes |
| Sample Preparation | Prepare a sample of 10 mg/mL polymer in the running buffer |

While the method described in this example refers to screening and identifying polymers that are substantive to a HAP surface, this method may be implemented in a similar manner to screen and identify polymers that are substantive to a different material. Depending on the material, the LC column that is utilized will need to be modified.

The LC column may be pre-conditioned prior to initiating the polymer screening. In certain embodiments, the LC column may be coated with sterilized saliva, as described with respect to FIG. 2B hereinbefore. In certain embodiments, the resulting chromatogram from a certain polymer injected into a bare HAP LC column (without sterilized saliva) may be the same (or substantially the same) as the resulting chromatogram the same polymer injected into a HAP LC column that has been coated with sterilized saliva. In other words, in certain embodiments, there may be no different in the chromatogram resulting from running a certain polymer through a HAP LC column with saliva or without saliva. In other embodiments, there could be a difference in the chromatogram resulting from running a certain polymer through a HAP LC column with saliva or without saliva. In such embodiments where there is a difference, the HAP LC column coated with sterilized saliva may provide results that are more representative of the test polymer’s performance in an individual’s oral cavity.

A plurality of polymers were screened, using the method described herein, to evaluate how substantive the test polymers are to a HAP surface. Once the HAP LC column was pre-conditioned, optionally coated with saliva, and the polymer samples were prepared, the samples were run through the HAP LC column, and each polymer’s retention time along with its associated area percentages were recorded, as summarized in Table 2 below.

TABLE 2

Retention Times and Associated Area Percentages for Various Polymers

| | Polymer | rt 1 | A% rt1 | rt2 | A% rt2 | rt3 | A% rt3 |
|---|---|---|---|---|---|---|---|
| E | Polymer 1 | 1.1 | 100 | -- | -- | -- | -- |
| | Polymer 2 | 1.5 | 100 | -- | -- | -- | -- |
| | Polymer 3 | 1.6 | 100 | -- | -- | -- | -- |
| | Polymer 4 | 1.6 | 100 | -- | -- | -- | -- |
| D | Polymer 5 | 1.6 | 12 | 2.3 | 88.4 | -- | -- |
| | Polymer 6 | 1.6 | 15 | 2.6 | 85 | -- | -- |
| | Polymer 7 | 1.5 | 13.4 | 2.6 | 86.6 | -- | -- |
| | Polymer 8 | 1.5 | 25 | 2.6 | 75 | -- | -- |
| | Polymer 9 | 1.5 | 28.4 | 2.5 | 71.6 | -- | -- |
| | Polymer 10 | 1 | 3.9 | 1.5 | 26 | 2.6 | 70 |
| C | Polymer 11 | 1.6 | 5.8 | 2.6 | 94 | 12.9 | 0.008 |
| | Polymer 12 | 2.6 | 100 | -- | -- | -- | -- |
| | Polymer 13 | 2.7 | 100 | -- | -- | -- | -- |
| | Polymer 14 | 1.7 | 4.6 | 2.8 | 95.4 | 13 | 0.07 |
| | Polymer 15 | 2.8 | 99.97 | 12.13 | 0.03 | -- | -- |
| | Polymer 16 | 2.6 | 99.9 | 11.7 | 0.1 | -- | -- |
| | Polymer 17 | 1.6 | 27 | 2.6 | 73 | 10.41 | 0.03 |
| | Polymer 18 | 1.02 | 14 | 2.6 | 86.2 | 11.3 | 0.02 |
| B | Polymer 19 | 1.7 | 5.5 | 3 | 88.6 | 7.6 | 5.9 |
| | Polymer 20 | 1.7 | 9.8 | 3 | 80.8 | 7.6 | 9.3 |
| | Polymer 21 | 2.6 | 95.3 | 8.2 | 4.7 | -- | -- |
| | Polymer 22 | 2.7 | 92.5 | 8.1 | 7.6 | -- | -- |
| | Polymer 23 | 1.7 | 2.2 | 3 | 97.8 | 6.8 | 0.001 |
| | Polymer 24 | 1.02 | 0.03 | 2.74 | 64.21 | 8.1 | 7.3 |
| | Polymer 25 | 1.8 | 95.4 | 8.5 | 4.6 | -- | -- |
| | Polymer 26 | 2.3 | 91.9 | 8.7 | 8.1 | -- | -- |
| | Polymer 27 | 2.8 | 89.5 | 8.1 | 10.5 | -- | -- |
| A | Polymer 28 | 2.9 | 82.7 | 7.9 | 17.3 | -- | -- |
| | Polymer 29 | 1 | 6.8 | 2.61 | 78.2 | 8.1 | 15 |
| | Polymer 30 | 1 | 19 | 2.6 | 55.3 | 8.3 | 26 |
| | Polymer 31 | 1 | 39 | 2.7 | 46 | 8.2 | 15.2 |
| | Polymer 32 | 1 | 31 | 2.6 | 54 | 8.4 | 15.3 |
| | Polymer 33 | 1.9 | 60 | 9.1 | 40 | -- | -- |

Table 2 depicts the retention time (rt) and associated area percentages (A%) for each peak related to a respective retention time for each polymer that was screened. The retention time being reflective of how long a polymer sticks to the column. Table 2 is arranged from the least sticky polymers being listed in the top (in Group E) to the most sticky polymers being listed in the bottom (in Group A). The more sticky polymers showed longer retention times and larger area percentages associated with peaks of the later retention times. More sticky polymers are believed to be more substantive to the HAP surface. Confirmatory experiments were conducted by subjecting certain polymers to experimental model 100, described with respect to FIG. 1 hereinabove.

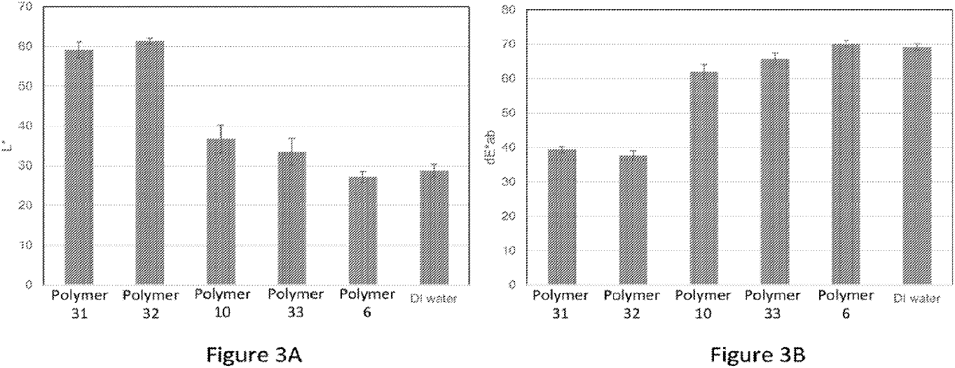

FIGS. 3A and 3B depict a chart summarizing the lightness and delta E*, respectively, measured for HAP disks after treatment with various polymers that were subj ected to confirmatory experiments in accordance with experimental model 100 (Polymer 31, Polymer 32, Polymer 10, Polymer 33, Polymer 6, DI Water). The compositions of the various polymers that were tested are as follows:
Polymer 31: a sodium salt of an AA-MA copolymer having a molecular weight of 70,000 g/mol and a molar ratio of acrylic acid to maleic acid of 1:0.3.
Polymer 32: a sodium salt of an AA-MA copolymer having a molecular weight of 50,000 g/mol and a molar ratio of acrylic acid to maleic acid of 1:0.6.
Polymer 10: a modified polycarboxylate sodium salt.
Polymer 33: polyethyleneimines (branched spherical polymeric amines).
Polymer 6: cationic coagulant polyelectrolyte polymers.

As seen in FIG. 3A, the leading samples (i.e., samples shown to be most sticky per Table 2) yielded a lightness L* of about 60, which is almost twice as much as was observed for the comparative polymers. As seen in FIG. 3B, the leading samples yielded a delta E* of about 40, which is almost 50% lower than the delta E* observed for comparative polymers. The best whitening effect was observed in HAP disks treated with Polymer 31 and Polymer 32 solutions, which were also the stickiest (and most substantive polymers) pursuant to the screening method described herein and the results summarized in Table 2 above.

The efficacy of these polymers in preventing stains and improving whitening effect was further evaluated in a mouthwash (MW) formulation and was conducted in accordance with experimental model 100 illustrated in FIG. 1 and described in detail hereinabove. The treatment solutions studied are listed in Table 3 below. Each treatment solution is associated with a code as summarized in Table 3 below.

TABLE 3

Treatment Solutions

| | |
|---|---|
| Code | Description |
| A1 | Homemade MW with 2% Polymer 31 (without flavor) |
| B1 | Homemade MW with 2% Polymer 32 (without flavor) |
| A2 | Homemade MW with 2% Polymer 31 (with flavor) |
| B2 | Homemade MW with 2% Polymer 32 (with flavor) |
| A3 | Commercial MW A with 2% Polymer 31 |
| B3 | Commercial MW A with 2% Polymer 32 |
| A4 | Commercial MW B with 2% Polymer 31 |
| B4 | Commercial MW B with 2% Polymer 32 |
| L3 | Commercial MW A |
| L4 | Commercial MW B |
| DI water | DI water |

The pH of the Polymer 31, 2 wt% polymer solution, was about 8.31. The pH of the Polymer 32, 2 wt% polymer solution, was about 8.40. When the polymers were incorporated into a mouthwash formula, the pH was adjusted to about 5.0.

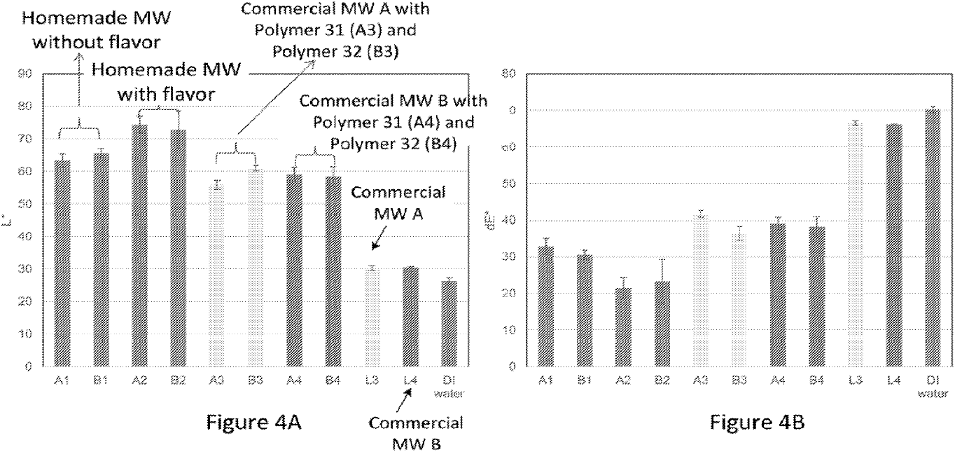

FIGS. 4A and 4B depict charts summarizing the lightness and delta E*, respectively, measured for HAP disks after treatment with various treatment solutions summarized in Table 3. As seen in FIG. 4A, the leading samples yielded a lightness L* of about 60 or greater, which is almost twice as much as was observed for the comparative treatment solutions, L3, L4, and deionized water. As seen in FIG. 4B, the leading samples yielded a delta E* of about 40 or less, which is almost 50% lower than the delta E* observed for comparative treatment solutions, L3, L4, and deionized water. The best whitening effect was observed for mouth wash samples which contained Polymer 31 and/or Polymer 32 (Codes A1, A2, A3, A4, B1, B2, B3, and B4), which were identified as most sticky according to the methods described herein and the results summarized in Table 2. In fact, Polymer 31 and/or Polymer 32 show an improvement in whitening effects of commercial mouth wash products that are presently on the market.

From these results, it appears that the stickiness of a polymer according to the methods described herein may assist in identifying lead polymers for improving anti-staining and whitening effects on a tooth surface.

Although this example was described with respect to screening polymers that are substantive to a tooth like surface (hydroxyapatite), the same method may be used to screen and identify polymers that are substantive to other surface materials. A more substantive polymer may deliver prolonged benefits to the material that it adheres to, such as, without limitations, whitening and anti-staining effects, active agents (e.g., anti-plaque active agents), sensitivity barriers, and the like.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” and “the” as used in this application and the appended claims should generally be construed to mean “one or more” unless specified otherwise or clear from context to be directed to a singular form. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

Reference throughout this specification to numerical ranges should not be construed as limiting and should be understood as encompassing the outer limits of the range as well as each number and/or narrower range within the enumerated numerical range.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number ± 10%, such that “about 10” would include from 9 to 11.

As used herein, the terms “active agent,” “active ingredient,” refer to any material that is intended to produce a therapeutic, prophylactic, or other intended effect, whether or not approved by a government agency for that purpose. These terms with respect to specific agents include all pharmaceutically active agents, all pharmaceutically acceptable salts thereof, complexes, stereoisomers, crystalline forms, co-crystals, ether, esters, hydrates, solvates, and mixtures thereof, where the form is pharmaceutically active.

As used herein, “substantive” refers to a measure of a polymer’s stickiness, retentiveness, or adhesion to a material.

As used herein, “saliva” encompasses a naturally occurring saliva as well as artificial saliva substitutes.

As used herein, “tooth whitening” refers to a lightening of tooth shade relative to the tooth shade prior to treatment. Lightening is assessed on an isolated or an in situ tooth by standard, art-recognized methods of assessing tooth shade, which include qualitative, quantitative and semiquantitative methods. For instance, lightening may be assessed by simple visual inspection, e.g., by comparing “before” and “after” photographs of the treated teeth. Alternatively, a tooth may be deemed whitened when the tooth shade relative to the tooth shade prior to treatment is two or more shades lighter, as assessed by Vita classical shade guide (preferably, under controlled visible light conditions) or two or more levels as assessed using the Vita Bleachedguide 3D-MASTER Shade system, which utilizes a multiple color spectrophotometer and includes half lightness levels.

As used herein, an “effective amount” of a polymer is intended to mean any amount of the polymer that will result in a therapeutic, prophylactic, or other intended effect, as defined herein, using methods of assessment known to the skilled artisan, with one or more treatments.

The present invention has been described with reference to specific exemplary embodiments thereof. The specification and drawings are, accordingly, to be regarded in an illustrative rather than a restrictive sense. Various modifications of the invention in addition to those shown and described herein will become apparent to those skilled in the art and are intended to fall within the scope of the appended claims.

1. A method for screening polymers that are substantive to a material, the method comprising:
running a solution of a test polymer through a liquid chromatography (LC) column comprising the material to determine a retention time profile for the test polymer,
wherein a longer retention time profile as compared to a baseline is indicative of the test polymer being more substantive to the surface as compared to the baseline.

2. The method of claim 1, wherein the baseline comprises a retention time profile for a reference polymer.

3. The method of claim 1, wherein the solution comprises from about 1 mg/mL to about 20 mg/mL of the test polymer.

4. The method of claim 1, wherein the running occurs at an isocratic flow ranging from about 0.1 ml/min to about 5 ml/min.

5. The method of claim 1, wherein the running occurs over a runtime ranging from about 1 minute to about 3 hours.

6. The method of claim 1, further comprising pre-conditioning the LC column prior to running the test polymer solution.

7. The method of claim 6, wherein pre-conditioning the LC column comprises performing one or more of (a) through (d) one or more times, wherein (a) through (d) are:
(a) washing the LC column with water,
(b) washing the LC column with a low ionic strength equilibration buffer,
(c) washing the LC column with a high ionic strength equilibration buffer, and
(d) equilibrating the LC column with a running buffer.

8. The method of claim 7, wherein the low ionic strength equilibration buffer comprises 10 mM sodium phosphate and a pH ranging from about 5.5 to about 7.

9. The method of claim 7, wherein the high ionic strength equilibration buffer comprises 500 mM sodium phosphate and a pH ranging from about 5.5 to about 7.

10. The method of claim 7, wherein the test polymer solution comprises from about 1 mg/mL to about 20 mg/mL of the test polymer in the running buffer.

11-16. (canceled)

17. A method for screening polymers that are substantive to a hydroxyapatite, the method comprising:
coating a liquid chromatography (LC) column comprising hydroxyapatite with sterilized saliva; and
running a solution of a test polymer through the LC to determine a retention time profile for the test polymer,
wherein a longer retention time profile as compared to a baseline is indicative of the test polymer being more substantive to the hydroxyapatite as compared to the baseline.

18. The method of claim 17, wherein the baseline comprises a retention time profile for a reference polymer.

19. The method of claim 17, wherein the running occurs at an isocratic flow ranging from about 0.1 ml/min to about 5 ml/min.

20. The method of claim 17, wherein the running occurs over a runtime ranging from about 1 minute to about 3 hours.

21. The method of claim 17, further comprising pre-conditioning the LC column prior to running the test polymer solution.

22. The method of claim 21, wherein pre-conditioning the LC column comprises performing one or more of (a) through (d) one or more times, wherein (a) through (d) are:
(a) washing the LC column with water,
(b) washing the LC column with a low ionic strength equilibration buffer,
(c) washing the LC column with a high ionic strength equilibration buffer, and
(d) equilibrating the LC column with a running buffer.

23-26. (canceled)

27. The method of claim 17, wherein the sterilized saliva is prepared by:
centrifuging saliva at about 1000 to about 3000 rpm to collect supernatant; and
sterilizing the saliva under ultraviolet light for about 0.5 hour to about 2 hours.

28. The method of claim 17, wherein coating the LC column with sterilized saliva comprises:
introducing about 1 mL to about 10 mL sterilized saliva directly to the LC column;
incubating the LC column with the sterilized saliva for about 5 minutes to about 5 hours; and
washing the incubated LC column with running buffer to wash out unbound sterilized saliva.

29. A liquid chromatography (LC) column for screening polymers that are substantive to a hydroxyapatite, the LC column comprising a hydroxyapatite LC column coated with sterilized saliva.

30. A method for preparing the LC column of claim 29, comprising:
introducing about 1 mL to about 10 mL sterilized saliva directly to the hydroxyapatite LC column;
incubating the hydroxyapatite LC column with the sterilized saliva for about 5 minutes to about 5 hours; and
washing the incubated hydroxyapatite LC column with running buffer to wash out unbound sterilized saliva.

31. (canceled)
